(19) United States
(12) Patent Application Publication
(10) Pub. No.: US 2017/0050143 A1
(43) Pub. Date: Feb. 23, 2017

(54) METHOD FOR REMOVING DUST FROM FLUE GAS USING EMULSION LIQUID MEMBRANE

(71) Applicant: NORTH CHINA UNIVERSITY OF SCIENCE AND TECHNOLOGY, Tangshan (CN)

(72) Inventors: Hongxia LI, Tangshan (CN); Junjie ZHANG, Tangshan (CN); Guojiang LI, Tangshan (CN); Qiangsan LV, Tangshan (CN); Hong YAN, Tangshan (CN); Xiang ZHAO, Tangshan (CN)

(21) Appl. No.: 15/344,606

(22) Filed: Nov. 7, 2016

Related U.S. Application Data
(63) Continuation-in-part of application No. PCT/CN2015/074576, filed on Mar. 19, 2015.

(30) Foreign Application Priority Data
May 7, 2014 (CN) 201410197021.7

(51) Int. Cl. B01D 53/22; B01D 21/24; B01D 47/02; B01D 17/06; B01D 47/06; B01D 67/00

(52) U.S. Cl. CPC B01D 53/228; B01D 47/06; B01D 67/0002; B01D 47/02; B01D 17/06; B01D 21/245

(57) ABSTRACT

A method for removing dust from flue gas using an emulsion liquid membrane, including: a) dissolving a surfactant into a membrane solvent to yield a membrane-forming liquid; stirring and injecting an internal phase liquid into the membrane-forming liquid to yield an emulsion; b) stirring and adding the emulsion to an external phase liquid to disperse the emulsion into the external phase liquid to yield an emulsion liquid membrane; c) allowing the emulsion liquid membrane to contact with a flue gas for removing dust; d) separating a dust-loaded emulsion, and demulsifying the dust-loaded emulsion under an electrostatic field to release the dust from the membrane-forming liquid; recycling the membrane-forming liquid to a); and e) allowing the dust released from the demulsification to precipitate in the form of a slurry and discharging the slurry.

### CROSS-REFERENCE TO RELATED APPLICATIONS

This application is a continuation-in-part of International Patent Application No. PCT/CN2015/074576 with an international filing date of Mar. 19, 2015, designating the United States, now pending, and further claims foreign priority benefits to Chinese Patent Application No. 201410197021.7 filed May 7, 2014. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

Field of the Invention

The invention relates to a method for removing dust from flue gas using an emulsion liquid membrane.

Description of the Related Art

Typical methods for removing dust from flue gas includes dry dedusting methods and wet dedusting methods. In general, the dry dedusting methods have good effect in removing large-sized dust but are ineffective in removing fine dust. The wet dedusting methods adopt water as the medium which is vaporized or atomized by high temperature flue gas and carried away by the flue gas. This consumes a large amount of water.

### SUMMARY OF THE INVENTION

In view of the above-described problems, it is one objective of the invention to provide a method for removing dust from flue gas using an emulsion liquid membrane.

To achieve the above objective, in accordance with one embodiment of the invention, there is provided a method for removing dust from flue gas using an emulsion liquid membrane. The method comprises:
a) uniformly mixing and dissolving a surfactant in a kerosene or a diesel oil to yield a membrane-forming liquid; stirring and injecting an internal phase liquid into the membrane-forming liquid to yield an emulsion;
b) stirring and adding the emulsion to an external phase liquid at a rotational speed of between 200 and 300 rpm to disperse the emulsion into the external phase liquid to yield an emulsion liquid membrane;
c) contacting the emulsion liquid membrane with flue gas to remove dust by counter flow spraying or in a reaction tank;
d) separating a dust-loaded emulsion, and demulsifying the dust-loaded emulsion under an electrostatic field to release the dust from the membrane-forming liquid; allowing a resulting mixture to stand for stratification, separating an upper layer to obtain the membrane-forming liquid, and recycling the membrane-forming liquid to a) for preparing the emulsion; and
e) allowing the dust released from the demulsification to precipitate at a bottom of a clarifier in the form of a slurry under the action of gravity, and discharging the slurry.

In a class of this embodiment, the emulsion liquid membrane is a water-in-oil type emulsion liquid membrane.

In a class of this embodiment, the surfactant has a hydrophilic-lypophilic balance of between 3 and 7, and the surfactant accounts for between 2 and 5 percent by volume of the membrane-forming liquid.

In a class of this embodiment, the surfactant is one selected from the group consisting of succinimide, bis-succinimide, and sorbitan fatty acid ester.

In a class of this embodiment, the internal phase liquid of the emulsion liquid membrane is water, saturated lime water, or brine water.

In a class of this embodiment, in a), the internal phase liquid is continuously added to the membrane-forming liquid while stirring; a volume ratio of the membrane-forming liquid to the internal phase liquid is between 1:0.5 and 1:1.5; and a rotational speed of the stirring is between 3000 rpm and 7000 rpm.

In a class of this embodiment, the external phase liquid of the emulsion liquid membrane is water or brine water; and a volume ratio of the emulsion to the external phase liquid is between 1:3 and 1:5.

In a class of this embodiment, when the dust removal is conducted in the mode of counter flow spraying, the emulsion liquid membrane is sprayed in a direction opposite to a flow direction of the flue gas to allow the emulsion liquid membrane to contact with the flue gas.

In a class of this embodiment, when the dust removal is conducted in the reaction tank, the flue gas is introduced to the emulsion liquid membrane while stirring at a rotational speed of between 200 and 300 rpm.

Advantages of the method for removing dust from flue gas according to embodiments of the invention are summarized as follows:
1. The emulsion drops in the emulsion liquid membrane system are able to fully contact with the flue gas due to their large specific areas, so that the dust removal effect is improved.
2. The emulsion liquid membrane belongs to the water-in-oil type. The membrane phase has a large electrostatic attraction force to the dust, and a surface of the emulsion drop is strongly adhesive to the dust, as a result, the dust is effectively removed from the flue gas.
3. When adopting the brine water or the saturated lime water as the internal phase liquid, the internal phase liquid has relatively high ion concentration, which is beneficial to the demulsification under the electrostatic field, so that the time for the demulsification is shortened and the demulsification efficiency is improved.
4. When adopting the brine water as the external phase liquid, acid pollutants including nitrogen oxides and sulfur dioxide are removed along with the dust removing process, so that the flue gas is purified.
5. The membrane-forming liquid has relatively high boiling point. The emulsion drops effectively reduces the water evaporation and decreases the amount of water carried away by the flue gas.
6. As the membrane-forming liquid released from the demulsification is indissoluble in water and the specific gravity of the membrane-forming liquid is lighter than water, the membrane-forming liquid suspends on the water surface and is then collected for reuse. Thus, the cost for dust removal is reduced.
7. The slurry is formed by the dust and the water after demulsification, precipitated at the bottom of the clarifier, and then easily discharged.

### BRIEF DESCRIPTION OF THE DRAWINGS

The invention is described hereinbelow with reference to the accompanying drawings, in which:

FIG. 1 is a diagram illustrating the principle of dust removal of a water-in-oil emulsion liquid membrane in accordance with one embodiment of the invention; and

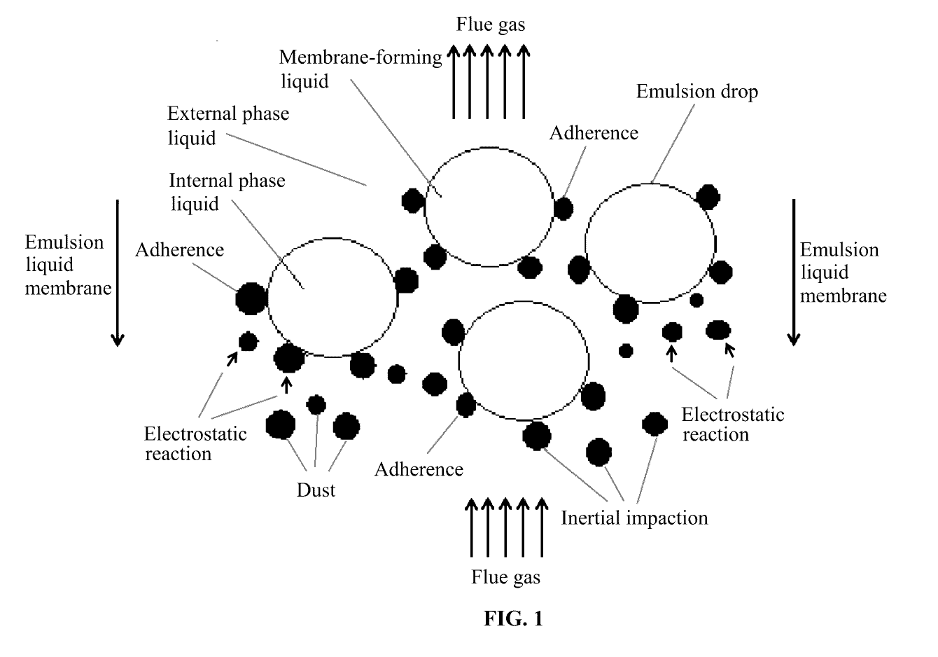

FIG. 2 is a flow chart of a method for removing dust from flue gas using a water-in-oil emulsion liquid membrane in accordance with one embodiment of the invention.

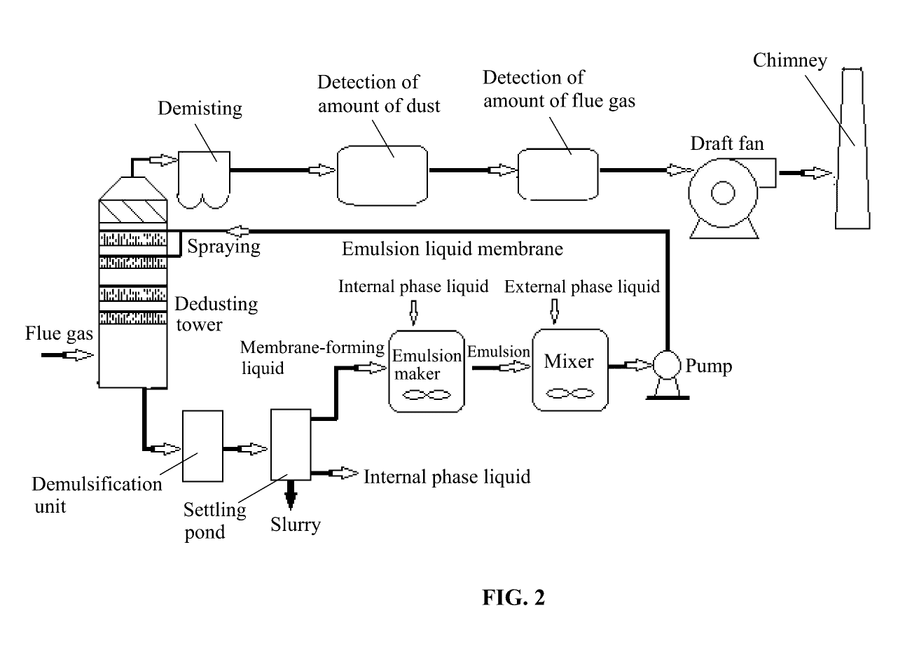

### DETAILED DESCRIPTION OF THE EMBODIMENTS

For further illustrating the invention, experiments detailing a method for removing dust from flue gas using an emulsion liquid membrane are described below. It should be noted that the following examples are intended to describe and not to limit the invention.

The method removing dust from flue gas using an emulsion liquid membrane is performed as follows:

1. Preparation of Emulsion Liquid Membrane

A surfactant is dissolved into a membrane solvent and uniformly stirred to form a membrane-forming liquid. An internal phase liquid is injected into the membrane phase while stirring to yield an emulsion. The emulsion is thereafter dispersed into water or brine water as an external phase liquid to prepare an emulsion liquid membrane.

2. Dust Removal of Flue Gas

The emulsion liquid membrane is sprayed into a dust collection tower in a direction opposite to a flow direction of the flue gas to allow the emulsion liquid membrane to contact with the flue gas for removing the dust. Or, the emulsion liquid membrane and the flue gas mixed in a reaction tank by stirring to allow the emulsion liquid membrane to contact with the flue gas for removing the dust.

3. Demulsification and Recycle of Membrane-Forming Liquid

A dust-loaded emulsion is separated and introduced to a demulsifier. Considering the internal phase liquid containing a relatively high ion concentration, an electrostatic field is applied to perform demulsification. A membrane-forming liquid released from the demulsification suspends on an upper layer and is collected and recycled for the emulsion preparation.

4. Discharge of Slurry

The dust released from the demulsification is allowed to precipitate in the form of a slurry and is discharged from a bottom of a clarifier.

### EXAMPLE 1

1. Preparation of water-in-oil emulsion: a diesel oil as a membrane solvent and bis-succinimide as a surfactant were mixed according to a volume ratio of the membrane solvent to the surfactant of 97:3 to fully dissolve the surfactant into the membrane solvent and to yield a membrane-forming liquid. Water of an equivalent volume as an internal phase liquid was gradually added to the membrane-forming liquid while stirring at a rotational speed of 3000 rpm. The stirring was continued for 10 min after the addition of the internal phase liquid so as to yield a water-in-oil emulsion.

2. Dust removal from flue gas: the water-in-oil emulsion was mixed with water according to a volume ratio of the emulsion to water of 1:5 to prepare 1000 mL of an emulsion liquid membrane. The emulsion liquid membrane was allowed to contact with a flue gas having a dust content of 200 mg/m³ and a flow rate of 2 L/min while stirring at a rotational speed of between 250 and 300 rpm for removing dust from the flue gas. After 60 min of treatment, the dust removal effect was 98 wt. %.

3. Demulsification and recycle of the membrane-forming liquid: a loaded emulsion was periodically discharged and demulsified under an electrostatic field. A resulting solution was transferred to a separator and allowed to precipitate. A membrane-forming liquid at an upper layer was separated for recycling for preparing the water-in-oil emulsion.

4. Discharge of slurry: a separated dust was discharged from a bottom of the separator in the form of a slurry.

### EXAMPLE 2

1. Preparation of water-in-oil emulsion: a diesel oil as a membrane solvent and sorbitan fatty acid ester as a surfactant were mixed according to a volume ratio of the membrane solvent to the surfactant of 96:4 to fully dissolve the surfactant into the membrane solvent and to yield a membrane-forming liquid. A saturated limewater as an internal phase liquid was gradually added to the membrane-forming liquid with a volume ratio of the membrane-forming liquid to the internal phase liquid of 1:0.5 while stirring at a rotational speed of 7000 rpm. The stirring was continued for 8 min after the addition of the internal phase liquid so as to yield a water-in-oil emulsion.

2. Dust removal from flue gas: the water-in-oil emulsion was mixed with water according to a volume ratio of the emulsion to water of 1:4 to prepare an emulsion liquid membrane. The emulsion liquid membrane was sprayed at a speed of 800 mL/min to contact with the flue gas having a dust content of 180 mg/m³ and a flow rate of 2 L/min for removing dust from the flue gas, in which, a flow direction of the emulsion liquid membrane is opposite to that of the flue gas. The dust removal effect was 98.5 wt. %.

3. Demulsification and recycle of the membrane-forming liquid: a loaded emulsion was periodically discharged and demulsified under an electrostatic field. A resulting solution was transferred to a separator and allowed to precipitate. A membrane-forming liquid at an upper layer was separated for recycling for preparing the water-in-oil emulsion.

4. Discharge of slurry: a separated dust was discharged from a bottom of the separator in the form of slurry.

### EXAMPLE 3

1. Preparation of water-in-oil emulsion: a kerosene as a membrane solvent and succinimide as a surfactant were mixed according to a volume ratio of the membrane solvent to the surfactant of 95:5 to fully dissolve the surfactant into the membrane solvent and to yield a membrane-forming liquid. A saturated brine water as an internal phase liquid was gradually added to the membrane-forming liquid while stirring with a volume ratio of the membrane-forming liquid to the internal phase liquid of 1:1.5 at a rotational speed of 4800 rpm. The stirring was continued for 10 min after the addition of the internal phase liquid so as to yield a water-in-oil emulsion.

2. Dust removal from flue gas: the water-in-oil emulsion was mixed with brine water according to a volume ratio of the emulsion to the brine water of 1:3 to prepare 1000 mL of an emulsion liquid membrane. The emulsion liquid membrane was allowed to contact with a flue gas having a dust content of 200 mg/m³ and a flow rate of 2 L/min while stifling at a rotational speed of 200 rpm for removing dust from the flue gas. And the dust removal effect was 99.2 wt. %.

3. Demulsification and recycle of the membrane-forming liquid: a loaded emulsion was periodically discharged and demulsified under an electrostatic field. A resulting solution was transferred to a separator and allowed to precipitate. A membrane-forming liquid at an upper layer was separated for recycling for preparing the water-in-oil emulsion.

4. Discharge of slurry: a separated dust was discharged from a bottom of the separator in the form of a slurry.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for removing dust from flue gas using an emulsion liquid membrane, comprising:
a) uniformly mixing and dissolving a surfactant in a kerosene or a diesel oil to yield a membrane-forming liquid; stirring and injecting an internal phase liquid into the membrane-forming liquid to yield an emulsion;
b) stirring and adding the emulsion to an external phase liquid at a rotational speed of between 200 and 300 rpm to disperse the emulsion into the external phase liquid, to yield an emulsion liquid membrane;
c) contacting the emulsion liquid membrane with flue gas to remove dust by counter flow spraying or in a reaction tank;
d) separating a dust-loaded emulsion, and demulsifying the dust-loaded emulsion under an electrostatic field to release the dust from the membrane-forming liquid; allowing a resulting mixture to stand for stratification, separating an upper layer to obtain the membrane-forming liquid, and recycling the membrane-forming liquid to a) for preparing the emulsion; and
e) allowing the dust released from the demulsification to precipitate at a bottom of a clarifier in the form of a slurry under the action of gravity, and discharging the slurry.

2. The method of claim 1, wherein the emulsion liquid membrane is a water-in-oil type emulsion liquid membrane.

3. The method of claim 1, wherein the surfactant has a hydrophilic-lypophilic balance of between 3 and 7; and the surfactant accounts for between 2 and 5 percent by volume of the membrane-forming liquid.

4. The method of claim 2, wherein the surfactant has a hydrophilic-lypophilic balance of between 3 and 7; and the surfactant accounts for between 2 and 5 percent by volume of the membrane-forming liquid.

5. The method of claim 1, wherein the surfactant is one selected from the group consisting of succinimide, bis-succinimide, and sorbitan fatty acid ester.

6. The method of claim 4, wherein the surfactant is one selected from the group consisting of succinimide, bis-succinimide, and sorbitan fatty acid ester.

7. The method of claim 1, wherein the internal phase liquid of the emulsion liquid membrane is water, saturated lime water, or brine water.

8. The method of claim 6, wherein the internal phase liquid of the emulsion liquid membrane is water, saturated lime water, or brine water.

9. The method of claim 1, wherein in a), the internal phase liquid is continuously added to the membrane-forming liquid while stirring; a volume ratio of the membrane-forming liquid to the internal phase liquid is between 1:0.5 and 1:1.5; and a rotational speed of the stirring is between 3000 rpm and 7000 rpm.

10. The method of claim 8, wherein in a), the internal phase liquid is continuously added to the membrane-forming liquid while stirring; a volume ratio of the membrane-forming liquid to the internal phase liquid is between 1:0.5 and 1:1.5; and a rotational speed of the stirring is between 3000 rpm and 7000 rpm.

11. The method of claim 1, wherein the external phase liquid of the emulsion liquid membrane is water or brine water; and a volume ratio of the emulsion to the external phase liquid is between 1:3 and 1:5.

12. The method of claim 10, wherein the external phase liquid of the emulsion liquid membrane is water or brine water; and a volume ratio of the emulsion to the external phase liquid is between 1:3 and 1:5.

13. The method of claim 1, wherein when the dust removal is conducted in the mode of counter flow spraying, the emulsion liquid membrane is sprayed in a direction opposite to a flow direction of the flue gas to allow the emulsion liquid membrane to contact with the flue gas.

14. The method of claim 12, wherein when the dust removal is conducted in the mode of counter flow spraying, the emulsion liquid membrane is sprayed in a direction opposite to a flow direction of the flue gas to allow the emulsion liquid membrane to contact with the flue gas.

15. The method of claim 1, wherein when the dust removal is conducted in the reaction tank, the flue gas is introduced to the emulsion liquid membrane while stirring at a rotational speed of between 200 and 300 rpm.

16. The method of claim 12, wherein when the dust removal is conducted in the reaction tank, the flue gas is introduced to the emulsion liquid membrane while stirring at a rotational speed of between 200 and 300 rpm.
